(19) United States
(12) Patent Application Publication
(10) Pub. No.: US 2014/0188532 A1
(43) Pub. Date: Jul. 3, 2014

(54) Multitenant Database Placement with a Cost Based Query Scheduler

(71) Applicant: NEC Laboratories America, Inc., Princeton, NJ (US)

(72) Inventors: Ziyang Liu, Santa Clara, CA (US); Vahit Hakan Hacigumus, San Jose, CA (US); Alex Pucher, Santa Barbara, CA (US)

(73) Assignee: NEC Laboratories America, Inc., Princeton, NJ (US)

(21) Appl. No.: 14/077,413

(22) Filed: Nov. 12, 2013

Related U.S. Application Data
(60) Provisional application No. 61/725,740, filed on Nov. 13, 2012.

(51) Int. Cl. G06Q 10/06

(52) U.S. Cl. CPC G06Q 10/0631
USPC 705/7.12

(57) ABSTRACT

Systems and methods are disclosed for placing tenants in a cloud based database server, by estimating with a processor a cost of placing a set of tenants on a server using a simulator; estimating a relative importance of different tenant's queries; and selecting an optimal server for each tenant based with a cost-based schedular to maximize profit using the simulator.

This application claims priority to U.S. Provisional Application Ser. No. 61/725,740 filed Nov. 13, 2012, the content of which is incorporated by reference.

### BACKGROUND

The present invention relates to tenant placement systems for multi-tenant databases.

Cloud-hosted databases are becoming mainstream infrastructure for internet services. Cloud users ask for consistent service quality and competitive pricing while cloud operators profit by consolidating their resources. This conflict of interest is difficult to resolve and a service level agreement (SLA) is often established between the user and the service provider.

With more applications utilizing cloud resources, multitenant databases have gained widespread acceptance. Using a pay-as-you-go model, cloud tenants avoid high capital expenditures which makes it much easier for them to turn their ideas into execution, and meanwhile, the service provider wins as well through economies of scale. Since many tenants' applications are small, it is important that the service provider consolidates multiple tenants on a single server in order to offer a low price and be profitable. On the other hand, doing so too aggressively may cause server overload and performance degradation. As a result, a service level agreement (SLA) is often established between the service provider and the tenant that associates the tenant's bill with criteria like query response time.

The way of placing tenants on the servers may significantly impact the servers' performance and ultimately the service provider's profit and the users' satisfaction. Since the goal of service provider's main objectives is profit maximization, it should be the optimization criterion for tenant placement. For example, it may not be a good idea to place many tenants with important, high-priority queries on the same server as they would compete with one another. There are several existing tenant placement strategies for cloud service providers. However, none of them is profit-driven or aims at maximizing the service provider's profit based on the tenants' SLAs.

In the past workload performance prediction has revolved around sampling a diverse set of queries, all of which are in the same schema and database. They relied on either parsing query plans to create comparisons to other queries or building models in which they compared hardware usage patterns of new queries to that of known queries. They predict how new queries will execute within the same environment and require extensive retraining when the database hardware changes.

In designing a good tenant placement strategy, a good tenant placement algorithm should be aware of the query scheduler used in the database. Query schedulers, as an integral part of database systems, are used to schedule queries submitted to a database that are queued up and waiting to be processed. A variety of schedulers are available such as first-come, first-served (FCFS), earliest deadline first (EDF), shortest job first (SJF), incremental cost-based scheduler (iCBS), etc. Different query schedulers use different methods to prioritize the queries, and the tenant placement algorithm should take advantage of the scheduling method to achieve good performances. As an example, consider two schedulers: first-come, FCFS and iCBS, the latter of which prioritizes queries submitted to a database according to their SLA function and expected execution time. For FCFS, a good placement strategy is to put high-value tenants (i.e., tenants with a high query rate and an SLA function that generates high profit if the performance criterion is met or imposes high penalty otherwise) together on the same server, and low-value tenants together on the same server. In this way, we can leave more resource headroom for the servers that contain high-value tenants (by placing a relatively small number of tenants on these servers) so that their overload probability is small, and leave less headroom for the servers that contain low-value tenants so that we have a good consolidation factor without incurring much penalty.

### SUMMARY

Systems and methods are disclosed for placing tenants in a cloud based database server, by estimating with a processor a cost of placing a set of tenants on a server using a simulator; estimating a relative importance of different tenant's queries; and selecting an optimal server for each tenant based with a cost-based schedular to maximize profit using the simulator.

Advantages of the preferred embodiments may include one or more of the following. Lower Cost/Higher Profit: Different placements of tenants have significant impact on the SLA violation rates of tenants' queries and hence the service provider's cost/profit. A good placement strategy consistently achieves a low violation rate and thus improves the profit of the service provider.

The simulator efficiently predicts the cost of placing a set of tenants on a server, which is used to guide the placement algorithm to achieve a high-quality tenant placement. The system supports SLA profit maximization for the cloud service provider, by optimizing the way we distribute a set of tenants on a set of servers. And in particular, the system uses tenant placement strategies for multitenant databases with cost-based query schedulers (CBS, iCBS, etc.), which is an advanced type of schedulers that prioritizes the queries with the goal of maximizing profit, and which works well with profit-based placement strategies. Different placements of tenants have significant impact on the service provider's profit, and thus a good placement strategy is highly desirable. The iCBS consistently outperforms FCFS for the same placement due to its scheduling advantages; for different schedulers, the relative effectiveness of tenant placement strategies may be different; our most advanced approach that uses the simulator to predict the cost of servers (as well as sorting the tenants for piecewise-linear SLAs) consistently achieves a lower cost compared with any other method. The system has a wide range of applicability, as it supports all piecewise-linear SLA functions and almost all response-time-based SLA functions used in practice are piecewise-linear; our approach does not have any restrictions on important parameters such as query rates, number of query classes, tenants' data sizes, etc.; and we support a variety of multi-tenancy models, including private database, private table, and shared table models.

### BRIEF DESCRIPTION OF THE DRAWINGS

FIG. 1 shows an exemplary system for performing Tenant Placement in Multitenant Databases with Cost-Based Query Scheduler.

FIG. 2 shows an exemplary process for determining the importance of each tenant.

FIG. 3 shows an exemplary process for placing n tenants on m servers.

FIG. 4 shows an exemplary computer to execute FIGS. 1-3.

### DESCRIPTION

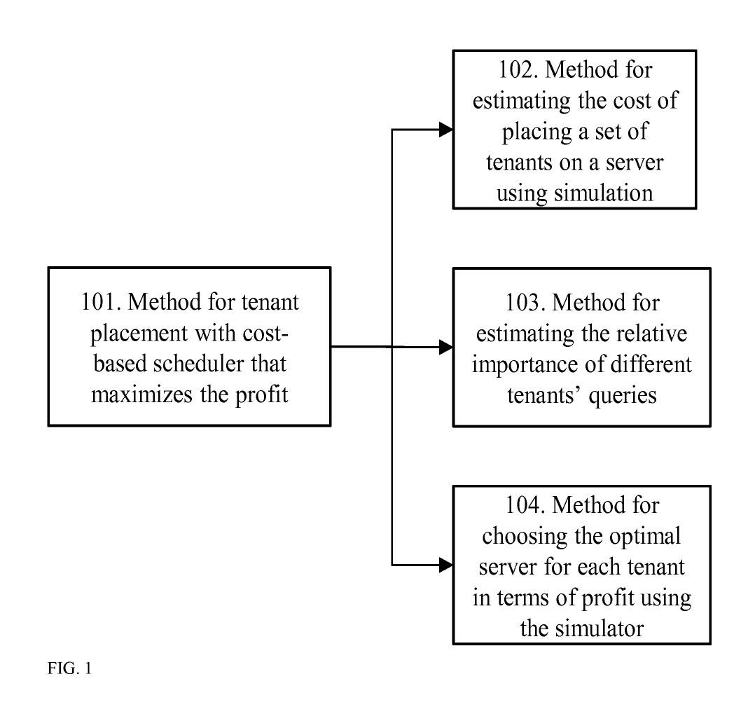

FIG. 1 shows an exemplary system for performing Tenant Placement in Multitenant Databases with Cost-Based Query Scheduler (101). The system includes a simulator (102). To accurately simulate workloads from multiple tenants, a comprehensive profiling stage is performed to obtain the distribution function of the query processing time of each query class. This ensures that the effects of occasional longer or shorter than usual processing times are accurately captured. The simulator is used to predict the cost of servers (as well as sorting the tenants for piecewise-linear SLAs) and this consistently achieves a lower cost compared with any other method.

Given a specific server load x, we make use of the simulator to estimate the relative priority of each tenant. The idea is to simulate n+1 workloads. The ith workload (1≦i≦n) consists only of tenant i's queries, and the n+1th workload consists of a mixture of all tenants' queries, in which the number of queries from each tenant is proportional to its average query rate. All workloads' load is x . For example, if the average running time of a query is 1 second and x=1.2, then we may generate 1200 queries during a 1000 second period.

For each of the first n workloads, after the simulation we compute the average cost (penalty) per query, which is simply the total SLA penalty divided by the total number of queries. For each tenant i, denote this cost as costₐₗₒₙₑ(i,x), i.e., the per-query cost when the workload consists of this tenant's queries alone. For the n+1th workload, we compute each tenant's individual average cost per query. For each tenant i, denote this cost by cost_{together}(i,x). By comparing costₐₗₒₙₑ(i,x) with cost_{together}(i,x), we can determine whether a tenant is prioritized or penalized when its query is mixed with other tenants' queries and when the load is x. If a tenant i has a high value of costₐₗₒₙₑ(i,x) and a relatively low value of cost_{together}(i,x), it means when running the mixed workload with load x, the queries of this tenant are prioritized and hence the lower cost. Likewise, a low value of costₐₗₒₙₑ(i,x) and high value of cost_{together}(i,x) means this tenant's queries get penalized. Thus we define the importance of a tenant i at load x as:

$$imp ( i , x ) = \frac{{cost}_{alone} ( i , x )}{{cost}_{together} ( i , x )} \qquad ( 1 )$$

To determine which tenant is generally more important, we integrate over load using the PDF f(x) of load:

imp(i)=∫ᵣ^{(x)}imp(i,x)·f(x)dx (2)

The system includes an estimation module for tenants (103). This ensures that tenants can be processed in the order of their importance to achieve a good mixture of high-value and low-value tenants on each server, which is important for achieving a low cost using cost-based schedulers.

The system also includes a module choosing the optimal server for each tenant (104). There are different ways to do so which results in different costs. The system is based on incremental cost which consistently achieves a low cost compared to other methods.

In the context of FIG. 1, an SLA is an agreement between the service provider and the tenants that associate the tenants' payments with their query performances. A tenant may have multiple query classes, each of which is associated with an SLA function. To be consistent with iCBS, we use response time based SLA functions, which is also the most commonly adopted type of SLA functions. iCBS supports all piecewise linear SLA functions, which is also the SLA functions that our approach supports. Each tenant may have multiple query classes, each with a different SLA. A sample piecewise linear SLA function associating revenue with query response time is shown in FIG. 1(a). Given a workload of queries, the total profit of the service provider is

$$Profit = {\sum }_{i} {r}_{i} - OpCost$$

where rᵢ is the revenue generated by a query i, while OpCost is the operational cost.

Let R(x) denote the SLA revenue function. The SLA penalty cost function C(x) is defined as

C(x)=R(0)−R(x)

where R(0) is the revenue if the query response time is zero. The system minimizes the SLA penalty cost given a set of tenants and a number of servers using C(x). Hereinafter, we simply use “cost” to refer to “SLA penalty cost”.

When there are queries submitted to the database that are queued up, iCBS prioritizes the queries based on its SLA function and expected execution time. For example, for one-step SLA functions, the iCBS score of a query (before its deadline has passed) is computed as

score=s/tₑ·e^{a(d t t}^{ₑ}⁾·e^{at}

where s, d, tₑ and t are the query's SLA penalty, deadline, execution time and the current time, respectively, and a is a tunable parameter which should be reasonably small so that cheap queries are generally preferred over expensive queries. Queries with short deadlines and higher SLA penalties are given higher scores. When a query cannot be finished by its deadline (i.e., d—t—tₑ<0), its iCBS score becomes zero and the query is dropped.

There are a spectrum of multitenancy models from complete separation (each tenant has its own virtual machine) to shared table (multiple tenants may share the same tables in the same database). In our implementation we use the private model (tenants share a database with separate tables), but our approach can also support private database and shared table models. One embodiment handles a specific type of service level agreement: single-step SLA, i.e., an SLA function that charges a flat penalty if the query does not meet the response time deadline.

In one embodiment, the system works with iCBS, which is based on a very effective cost-based scheduling algorithm, CBS. With iCBS, if high-value tenants and low-value tenants co-locate on the same server, iCBS will protect high value tenants by starting to sacrifice tenants with the lowest values in case of overload. Thus when we use iCBS, it can work better if we mix high-value and low-value tenants together. In this way, in case of overload, iCBS can make sure high-value tenants are prioritized, and if it must drop some queries or violate some SLAs, it starts doing so with low-value tenants. And since high-value tenants are distributed across different servers, their competition is minimized. Compared with the placement strategy for FCFS, this placement strategy for iCBS does not require us to leave much headroom on any server in the fear of not being able to service high-value queries in case of overload, and thus it makes better utilization of the servers. iCBS is extremely effective in terms of cost minimization in an environment of differentiated database services. The system provides a placement algorithm for the iCBS scheduler. A potentially good placement strategy with iCBS scheduler is to mix high-value and low-value tenants on the same server. However, iCBS dynamically adjusts the execution order of the queries in the queue based on various parameters, and the relative priority of a query may change with time, making it difficult to judge the tenants' relative values, or importances. To overcome this challenge, the simulator simulates tenants' workloads. We use it to simulate each tenant's queries running alone as well as all tenants' queries mixed together.

Based on each tenant's individual performance as well as the performance when mixing with other tenants, we assign a score to each tenant that represents its relative value, and perform tenant placement accordingly. Furthermore, there can be multiple placement strategies. Instead of straightforward ones like round robin, we argue that a placement strategy oblivious of different SLAs of different tenants would likely lead to poor performance. To optimize, we make use of the simulator which helps estimate the profit/penalty of a server with a certain subset of tenants. Then, we place the tenants on the servers based on the server's profit/penalty. We further discuss two simulation-based approach, one placing tenants based on the total penalty of a server, the other based on the incremental penalty of a server.

The system performs tenant placement in tenant databases with the goal of maximizing the service provider's profit and with a cost based query scheduler. By analyzing the impact of query schedulers on the placement strategy, the query scheduler performance is taken into account while designing the tenant placement algorithm. For iCBS query scheduler, a simulation-based approach estimates the relative value of the tenants. Ttwo placement strategies utilize the estimated tenant values for tenant placement. Our analysis and experimental evaluation in this paper gives service providers insightful information on how to select a tenant placement strategy given a specific scenario (tenant workload, SLAs, and query scheduler).

The system of FIG. 1 differs from existing tenant placement strategies for cloud service providers in that none of them is profit-driven or aims at minimizing the SLA violation penalties, and none of them studies tenant placement for cost-based query schedulers. Conventional systems do not use SLA functions and optimize on other criteria such as number of servers. They use simple heuristics such as best fit and simulated annealing, which are insufficient when SLAs are taken into account and different queries may have different values to the service provider. Some other works use throughput-based service-level objectives (SLO), but there's no mapping from SLO to profit, and they only allow a fixed number of tenant types and a fixed workload for each tenant. Furthermore, when cost-based schedulers are used, there are more opportunities to optimize the placement of tenants which is not addressed by any previous attempt.

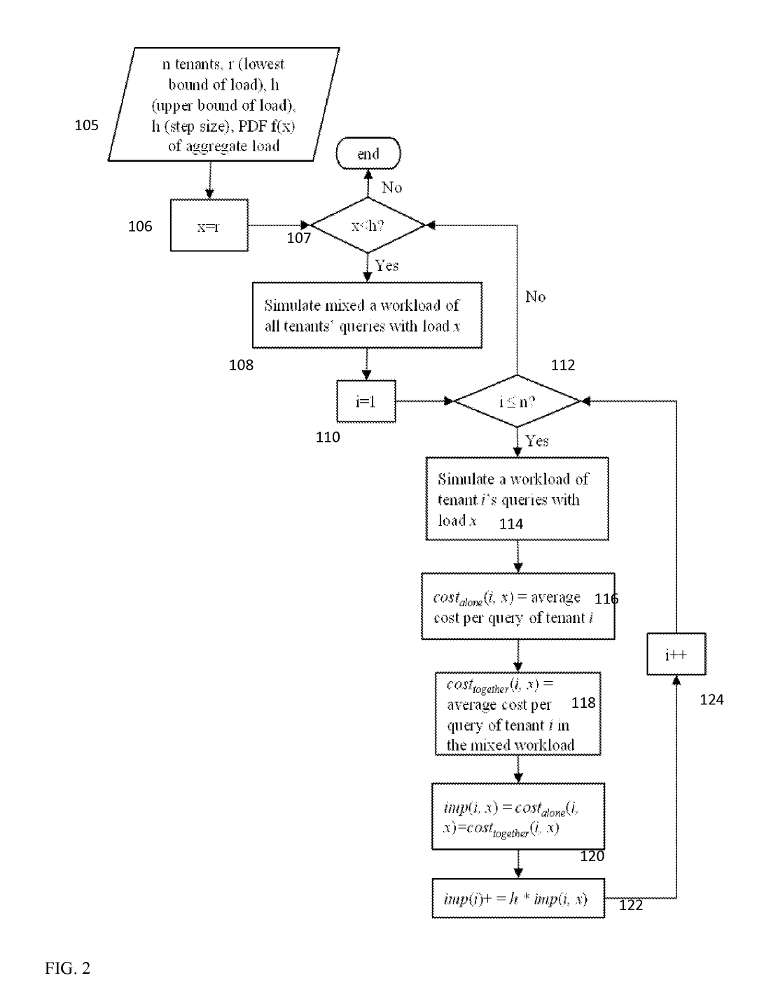

FIG. 2 shows an exemplary process for determining the importance of each tenant. The process receives as inputs n the number of tenants, r the lowest bound of load, h the upper bound of load, h, step size, and probability density function (PDF) of an aggregate load (105). Next, the process sets x to r (106). The process then checks if x<h (107) and if not the process exits and otherwise the process simulates a mixed workload of all tenants' queries with the load x (108). The process then sets I to 1 (110) and checks if i is less than or equal to n (112). If so, the process simulates a workload of tenant i's queries with load x (114). The process then determines the cost as an average cost per query of tenant I in the mixed workload (118). The process then set the importance (120) and cumulates the importance determination (122). The process increments i and loops back to 112 to continue processing.

One implementation of the process for Worst Fit with Simulator-based Placement is detailed next. Our goal for simulation is to create a sufficiently accurate relative prediction, rather than absolute prediction, as we use the simulator to select the server with the lowest cost compared with other servers, rather than predict the absolute cost of a server. Our simulator uses discrete event simulation. Queries are generated and managed using the same implementation as a real run, but the system timer and query execution are replaced using virtual counterparts. Given a set of tenants it is obviously infeasible to tune the simulator using all possible subsets of tenants, instead, tradeoffs should be made so that simulator tuning is completed in polynomial time. Our observation is that the average execution time of a query generally depends on two parameters: the total working set size of all tenants on a server, and total query arrival rate of all tenants on a serve. The size of the working set affect buffer pool utilization, and since we use multiple database connections on each server, different query arrival rates result in different levels of parallelism.

In order to make the simulator accurate, instead of using a single value to represent the average execution time of each query class, we maintain a distribution function of each query class, for each value of working set size and query rate. The values of the distribution function are normalized by the average execution time of the query class it represents. When we use the simulator to predict the cost of a workload, for each query in the workload, its simulated execution time is randomly generated according to the distribution of the query class given the working set size and query rate. This enables the simulator to achieve reasonably performance. The average prediction error in our experiments is 21.5% with a standard deviation of 15.3%. Although predictions are far from accurate in the absolute sense, they are sufficiently precise to distinguish well-preforming placements from others. A super-linear improvement in the quality of placements can be generated using the simulator and simulation accuracy may prove valuable in achieving even better placement quality.

With the simulator, we can now select the server for each tenant based on the costs of the servers. To balance the cost of the servers, one may want to place a tenant on the server that currently has the lowest cost. However, note that the server that currently has the lowest cost does not necessarily have the smallest cost increase, or delta cost after adding the current tenant. This is because the cost of a server generally increases super-linearly with the load. For example, when the load increases from 0.8 to 0.9, all other things being equal, the delta cost can be much higher than the delta cost when the load increases from 0.7 to 0.8, since the overload probability increases much higher in the former case. To see this, suppose query arrival of tenants on a server is a Poisson process with a mean rate of λ queries per minute, i.e., Pois(λ), and the arrival rate corresponding to full load (i.e., server load=1) is λ₁. The following inequality holds for all λ′<λ and λ+Δ≦λ₁:

Pr(λ+Δ>λ₁)−Pr(λ>λ₁)>Pr(λ′+Δ>λ₁)−Pr(λ′>λ₁)

This indicates that the overload probability increases more when the aggregated query rate goes from λ to λ+Δ. Therefore, even though a server currently has a low cost, if it has a high load (because the tenants on this server have low-penalty SLA functions), it may not be desirable to select this server for the next tenant, because its cost after adding this tenant may increase a lot. The following example illustrates this effect.

Thus to minimize the total cost of all servers, for each tenant t, we choose to place it on a server, such that this server has the smallest delta cost after adding t. The method for Worst Fit Strategy for Tenant Placement with iCBS, Using Simulator for Cost Balancing is as follows:

```
Input : n tenants, m servers, workload information and
        SLA function of each tenant
Output: Tenant placement, i.e., a mapping from tenants
        to servers
Sort the tenants in increasing order of s/t · e^{-a(d-t)}
T = {t₁, ... , tₙ} = sorted tenants
foreach tᵢ ε T do
  | minDeltaCost = ∞
  | destination = −1
  | for j = 1 to m do
  | | Estimate the cost of server j using the simulator,
  | | denoted as currCost
  | | Add tᵢ to server j
  | | Estimate the cost of server j using the simulator,
  | | denoted as newCost
  | | deltaCost = newCost − currCost
  | | if deltaCost < minDeltaCost then
  | | | minDeltaCost = delatCost
  | | | destination = j
  | | end
  | | Remove tᵢ from server j
  | end
  | Add tᵢ to server destination
end
```

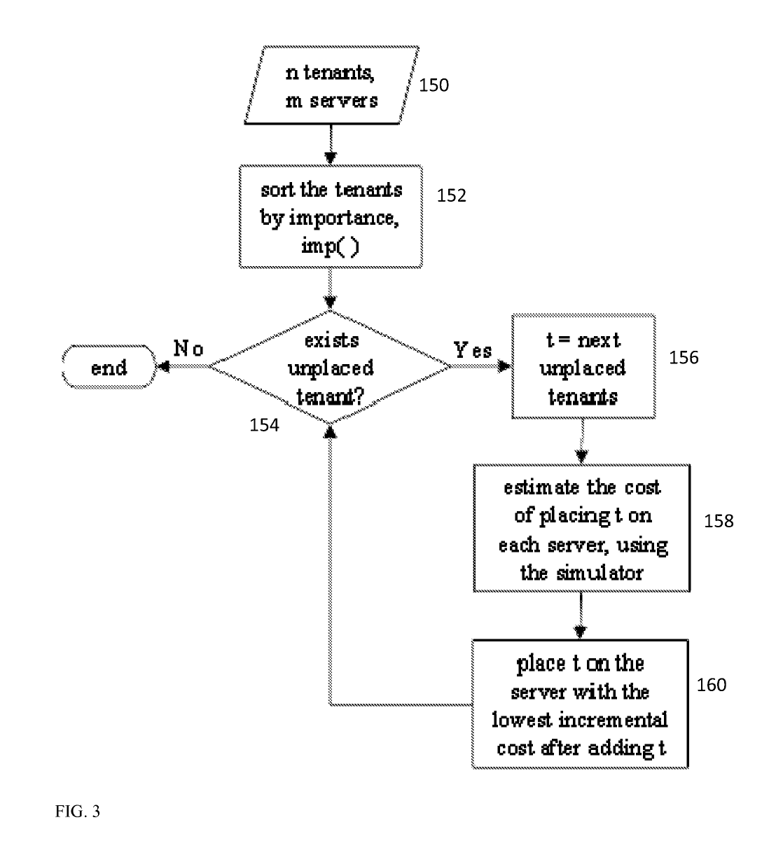

Piecewise linear SLAs are more difficult to handle in that relative “urgency” of processing a query may change with time. An example is shown in FIG. 3: assuming the execution time of both queries is 0, q₁ has a lower priority than q₂ before t since the SLA of q₂ increases faster, and q₁ has higher priority afterwards. This means that when the server is slightly overload (the wait time is short), some queries have priority over other queries; and when the server is heavily overload (the wait time is long), some other queries may have high priority. Thus we need to measure the general importance of a query compared with other queries, i.e., the general likelihood of this query being preferred by iCBS compared with others.

To do so, ideally we should integrate over query wait time in the queue, since given a specific wait time, each query has a fixed iCBS score. The problem, however, is that it is very difficult to compute a reasonable probability distribution function for query wait time. Thus we opt to integrate over server load and make use of the simulator discussed in Section 3.2.3. Assuming the average query arrival rate of each tenant follows normal distribution (which is generally the case for Web services such as the number of requests sent to Flickr servers), the total query arrival rate of a server also follows normal distribution whose average is the total average query arrival rates of all tenants on the server. The execution time of the queries of for a set of tenants on a server can be obtained through the profiling stage performed for the simulator, and thus the probability density function (PDF) of the server load can be obtained, since load is the product of query arrival rate and execution time. Let f(x) denote the PDF of server load.

Given a specific server load x, we make use of the simulator to estimate the relative priority of each tenant. The idea is to simulate n+1 workloads. The i th workload (1≦i≦n) consists only of tenant i's queries, and the n+1th workload consists of a mixture of all tenants' queries, in which the number of queries from each tenant is proportional to its average query rate. All workloads' load is x. For example, if the average running time of a query is 1 second and x=1.2, then we may generate 1200 queries during a 1000 second period.

For each of the first n workloads, after the simulation we compute the average cost (penalty) per query, which is simply the total SLA penalty divided by the total number of queries. For each tenant i, denote this cost as costₐₗₒₙₑ(i,x), i.e., the per-query cost when the workload consists of this tenant's queries alone. For the n+1th workload, we compute each tenant's individual average cost per query. For each tenant i, denote this cost by cost_{together}(i,x). By comparing costₐₗₒₙₑ(i,x) with cost_{together}(i,x), we can determine whether a tenant is prioritized or penalized when its query is mixed with other tenants' queries and when the load is x. If a tenant i has a high value of costₐₗₒₙₑ(i,x) and a relatively low value of cost_{together}(i,x), it means when running the mixed workload with load x, the queries of this tenant are prioritized and hence the lower cost. Likewise, a low value of costₐₗₒₙₑ(i,x) and high value of cost_{together}(i,x) means this tenant's queries get penalized. The importance of a tenant i at load x as:

$$imp ( i , x ) = \frac{{cost}_{alone} ( i , x )}{{cost}_{together} ( i , x )}$$

To determine which tenant is generally more important, we integrate over load using the PDF f(x) of load:

imp(i)=∫ᵣ^{(x)}imp(i,x)·f(x)dx

where r is close to but smaller than 1, for example, 0.7. r should be smaller than 1 because noticeable queuing delay starts to occur before the server load exceeds 1 (for example, in an M/M/1 queue with 80% load, the percentage of queries whose wait time exceeds ten times their running times is as large as 12%). The integral can be computed using numerical methods such as discretization, where we need to choose an upper bound of x (such as 1.5) and a step size h (such as 0.01). The process is shown in Algorithm 4. Since simulation is fast and tenant placement is not time critical, efficiency of this approach should not pose problems in practice. The value of imp(i) can be used to sort the tenants for worst-fit.

Turning now to FIG. 3, an exemplary process for placing n tenants on m servers is disclosed (150). First the process sorts tenants by importance (152). The process then checks for any unplaced tenants (154), and if there is no unplaced tenants the process exits and otherwise the process sets t to the next unplaced tenant (156). The process then estimates the cost of placing t on each server using the simulator (158). The process then places t on the server with the lowest incremental cost after adding t (160).

Our experiments using the TPC-W benchmark confirmed all expectations mentioned above, i.e., (1) when profit maximization is the goal, iCBS consistently outperforms FCFS for the same placement; (2) the query scheduler affects the qualities placement strategies. A placement may be better for a given query scheduler and tenant workload, but worse for another query scheduler or tenant workload; (3) for iCBS scheduler, placing tenants without considering their SLAs (e.g., round robin or load balancing) leads to relatively undesirable performance, especially if tenants' SLA functions are complex which presents more opportunity for optimization; and (4) for iCBS, simulation based approach generally achieves a consistent and good performance, and our placement strategy that places tenants based on the incremental penalty of a server achieves the best performance when the SLA functions are complex.

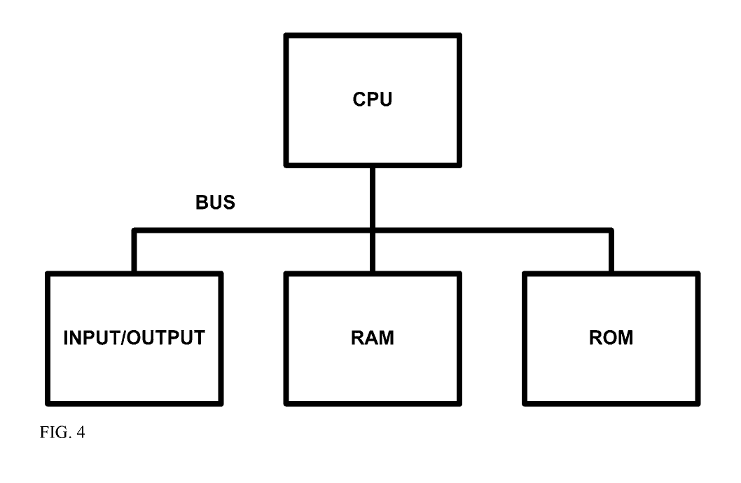

The invention may be implemented in hardware, firmware or software, or a combination of the three. FIG. 4 shows an exemplary computer to execute FIGS. 1-3. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself

What is claimed is:

1. A method for placing tenants in a cloud based database server, comprising:
estimating with a processor a cost of placing a set of tenants on a server using a simulator;
estimating a relative importance of different tenant's queries; and
selecting an optimal server for each tenant based with a cost-based schedular to maximize profit using the simulator.

2. The method of claim 1, comprising receiving a service level agreement (SLA) for mapping from tenants to servers

3. The method of claim 1, comprising simulating a mixed workload of all tenant's queries with a load.

4. The method of claim 1, comprising determining an average cost per query of a tenant.

5. The method of claim 1, comprising determining an average cost per query of tenant in a mixed workload.

6. The method of claim 1, comprising determining an importance of a tenant based on an average cost per query of a tenant alone and an average cost per query of a tenant in a mixed workload.

7. The method of claim 1, comprising determining an importance of a tenant i at a load x as:
$$imp ( i , x ) = \frac{{cost}_{alone} ( i , x )}{{cost}_{together} ( i , x )} .$$

8. The method of claim 1, comprising determining which tenant is more important by integrating a probability density function (PDF) of an aggregate load f(x) of load:
imp(i)=∫ᵣ^{(x)}imp(i,x)·f(x)dx
where r is approximately near one.

9. The method of claim 1, comprising estimating a cost of placing a tenant on a server using a simulator and placing the tenant on the server with the lowest incremental cost after adding the tenant.

10. The method of claim 1, comprising applying a worst fit strategy for tenant placement with an incremental cost-based scheduler (iCBS) and the simulator for cost balancing.

11. A system for placing tenants in a cloud based database server, comprising:
estimating with a processor a cost of placing a set of tenants on a server using a simulator;
estimating a relative importance of different tenant's queries; and
selecting an optimal server for each tenant based with a cost-based schedular to maximize profit using the simulator.

12. The system of claim 11, comprising code for receiving a service level agreement (SLA) for mapping from tenants to servers

13. The system of claim 11, comprising code for simulating a mixed workload of all tenant's queries with a load.

14. The system of claim 11, comprising code for determining an average cost per query of a tenant.

15. The system of claim 11, comprising code for determining an average cost per query of tenant in a mixed workload.

16. The system of claim 11, comprising code for determining an importance of a tenant based on an average cost per query of a tenant alone and an average cost per query of a tenant in a mixed workload.

17. The system of claim 11, comprising code for determining an importance of a tenant i at a load x as:
$$imp ( i , x ) = \frac{{cost}_{alone} ( i , x )}{{cost}_{together} ( i , x )} .$$

18. The system of claim 11, comprising code for determining which tenant is more important by integrating a probability density function (PDF) of an aggregate load f(x) of load:
imp(i)=∫ᵣ^{(x)}imp(i,x)·f(x)dx

19. The system of claim 11, comprising code for estimating a cost of placing a tenant on a server using a simulator and placing the tenant on the server with the lowest incremental cost after adding the tenant.

20. The system of claim 11, comprising code for applying a worst fit strategy for tenant placement with an incremental cost-based scheduler (iCBS) and the simulator for cost balancing.
